(19) United States
(12) Patent Application Publication
(10) Pub. No.: US 2025/0284084 A1
(43) Pub. Date: Sep. 11, 2025

(54) METHOD AND APPARATUS FOR DEPLOYMENT OF A COMMUNICATION LINE ONTO A SURFACE

(71) Applicant: TRAXyL, Inc., Gainesville, VA (US)

(72) Inventor: Daniel R. Turner, Gainesville, VA (US)

(21) Appl. No.: 19/070,250

(22) Filed: Mar. 4, 2025

Related U.S. Application Data
(60) Provisional application No. 63/561,578, filed on Mar. 5, 2024.

(51) Int. Cl. G02B 6/50

(52) U.S. Cl. CPC G02B 6/504

(57) ABSTRACT

The subject matter of this specification can be embodied in, among other things, a method for adhering a tubular assembly onto a constructed surface, and the method includes removing a portion of the constructed surface to form a recess below a major plane of the constructed surface, arranging the tubular assembly partly within the recess, applying an uncured protectant, and curing the uncured protectant to protectively encase the tubular assembly.

### CROSS-REFERENCE TO RELATED APPLICATIONS

This application claims the benefit of priority to U.S. Provisional Application No. 63/561,578, filed on Mar. 5, 2024, the contents of which are hereby incorporated by reference.

### TECHNICAL FIELD

The present disclosure relates generally to systems, methods, and apparatuses laying out a communication line and using a protectant to adhere and encase the communication line onto a surface.

### BACKGROUND

Communication lines or communication cables (i.e., examples of tubular bodies) provide useful conduits to transfer information (e.g., audio, visual, etc.) using modern technology. An example of a communication line is a fiber optic cable. The deployment and installation of communication lines, however, can be challenging for several reasons. For example, communication lines may need to extend over relatively long distances to, e.g., provide telecommunications to a commercial or residential building. Additionally, the communication lines may need to be accessible (e.g., for maintenance or repairs). At the same time, however, the communication lines may need to be protected from the environment and are often preferred to be hidden from view.

The usual process for installing a communication cable over a relatively long distance may include extruding plastic core tubes around, e.g., fibers, helically wrapping the tubes around a central strength member, building up several layers of protective sheathing, surrounding the sheathing with a protective material (armor) such as steel, and surrounding the armor with a heavy polymer jacket. Once a cable is manufactured, it can be pulled through conduits, hung along telephone poles, and/or buried inside trenches. Additional possibilities include what is known as “micro trenching” (see e.g., International Patent Application Publication No. 09/935,346), where a small trench is cut into the road surface or the ground. The cable is then installed within the micro-trench or installed on a roadway in the layers of protective sheathing as described above. Another example is described in U.S. Patent Application Publication No. 2002/0038716 where a flat fiber conduit is used for further protection.

The use of armor and other materials can increase the weight, fabrication cost, and installation footprint of the communication cable. The larger installation footprint often requires significant disruption and repair of the installed route, each of which can contribute to higher installation cost.

When installing below the surface, communication cables can either be directly buried or installed into a conduit to further protect the cable. As noted above, the cable and conduit are often installed by trenching into the ground. The use of the conduit requires the added cost and overhead of conduit installation along with the fiber cable manufacturing and installation. Additionally, cutting the micro-trench adds expense and time to the installation process.

Plowing, direct burial, or other similar cable installation methods often require an array of machines. For example, a machine that utilizes a cutting blade to trench through soil or other natural ground substances may be needed. The communication cable may be installed in a process described in French Patent No. 2,762,155, which involves: (i) cutting a trench, (ii) burying a cable in the trench; and then (iii) backfilling the trench with a filler material suitable for the ground surface. This installation technique may cause significant disruption to local roadway infrastructure with attendant business impacts and transportation delays.

Installing a communication cable by micro-trenching is similar to a trenching or plowing install, but the cutting tool and ground opening are smaller. Less filler material may also be required. The micro-trenching installation technique is mainly used on roadways and often utilizes a heavy duty diamond saw blade that cuts a narrow (e.g., only a few inches wide) section of a roadway or similar surface to a predetermined depth depending on the location. A communication cable is installed, or micro-duct is inserted for later filling with a communication cable. After that, the micro-trench is backfilled with an aggregate and another acceptable material. The risks of this technique (e.g., as described in International Patent Application Publication No. 09/935,346) include accidentally severing an existing utility line, damaging the integrity of the road surface, and risks to installers due to traffic and other safety concerns. Micro-trenching is not preferred in surfaces such as in private roads, shallow road surfaces, bridges, and tunnels, to name a few.

The present disclosure is directed to overcoming these and other problems of the prior art and may provide a more efficient and/or more robust technique to deploy a tubular assembly, such as a communication line, in or on a paved surface.

### SUMMARY

In general, this document systems, methods, and apparatuses laying out a communication line and using a protectant to adhere and encase the communication line onto a surface.

In an example implementation, a method for adhering a tubular assembly onto a constructed surface includes removing a portion of the constructed surface to form a recess below a major plane of the constructed surface, arranging the tubular assembly partly within the recess, applying an uncured protectant, and curing the uncured protectant to protectively encase the tubular assembly.

Various implementations can include some, all, or none of the following features. The method can include shaping the uncured protectant before curing the uncured protectant such that the uncured protectant has a different cross-sectional shape after the shaping than prior to the shaping. The shaping can be performed after the uncured protectant is applied onto the tubular assembly. The tubular assembly can be applied directly to the recess, and the uncured protectant is applied directly onto the tubular assembly. The curing of the uncured protectant can form a cured protectant that protectively encases the tubular assembly at least partly within the recess, the cured protectant being an outermost layer protecting the tubular assembly at least partly within the recess. The tubular assembly can have a predetermined thickness, and the recess has a depth less than the predetermined thickness. The method can include applying the uncured protectant onto the tubular assembly, and curing the uncured protectant to cover the tubular assembly. The method can include applying the uncured protectant within the recess, and curing the uncured protectant to cover the tubular assembly. A first portion of the tubular assembly can be arranged below the major plane and a second portion of the tubular assembly can extend beyond the major plane, and the uncured protectant can be cured to protectively encase the first portion within the recess and cover the second portion beyond the major plane. The tubular assembly can include an optical conductor.

In an example embodiment, an apparatus for adhering a tubular assembly to a constructed surface includes a main body moveable in an advancing direction, the main body possessing a forward end and a rear end, a receiver configured to store a tubular assembly having a predetermined thickness, the receiver being mounted on the main body, a container configured to store an uncured protectant, the container being mounted on the main body, a surface modification apparatus connected to the main body, the surface modification apparatus being configured to contact the constructed surface at a contact point to form a recess below a major plane of the constructed surface when the apparatus moves in the advancing direction, a tubular assembly applicator configured to receive a portion of the tubular assembly from the receiver and configured to arrange the tubular assembly partly within the recess, and a protectant applicator connected to the container and configured to eject the uncured protectant wherein the uncured protectant is configured to cure after the uncured protectant is applied.

Various embodiments can include some, all, or none of the following features. The surface modification apparatus can be a grinder. The surface modification apparatus can be a wheel. The uncured protectant can be a resin. The uncured protectant can be configured to be cured by application of a catalyst configured to initiate a curing process. The surface modification apparatus can be configured to form the recess to a depth less than the predetermined thickness below the major plane. The protectant applicator can be configured to eject the uncured protectant onto the tubular assembly, and the protectant applicator is positioned such that ejected uncured protectant is applied after the tubular assembly has been arranged by the tubular assembly applicator. The protectant applicator can be configured to eject the uncured protectant into the recess, and the protectant applicator is positioned such that ejected uncured protectant is applied after the tubular assembly has been arranged by the tubular assembly applicator. The protectant applicator can be configured to eject the uncured protectant into the recess, and the protectant applicator is positioned such that ejected uncured protectant is applied before the tubular assembly is arranged by the tubular assembly applicator. The tubular assembly applicator can be configured to arrange the tubular assembly partly within the recess such that a first portion of the tubular assembly is arranged below the major plane and a second portion of the tubular assembly extends beyond the major plane. The tubular assembly can include an optical conductor.

In another example embodiment, a tubular assembly includes a tubular body having a predetermined first cross-sectional shape and a predetermined first cross-sectional area, and a compliant jacket coaxially surrounding the tubular body and having a predetermined second cross-sectional shape and a predetermined second cross-sectional area.

Various embodiments can include some, all, or none of the following features. The tubular body can include one or more elements comprising one or more of an optical conductor, an electrical conductor, a thermal conductor, or luminal tube. The tubular body can include two or more of the elements arranged with a predetermined spacing. The tubular assembly can include a protective covering coaxially surrounding the tubular body. The compliant jacket can include an at least partly compressible material, wherein the compliant jacket is at least partly compressible from the predetermined second cross-sectional shape to a third cross-sectional shape different from the second cross-sectional shape and having a third cross-sectional area less than the second cross-sectional area. The compliant jacket can include a substantially incompressible material, wherein the compliant jacket is transformable from the predetermined second cross-sectional shape to a third cross-sectional shape different from the second cross-sectional shape and having the second cross-sectional area. The compliant jacket can include an elastic material, wherein the compliant jacket is configured to be distorted from the predetermined second cross-sectional shape to a third cross-sectional shape different from the second cross-sectional shape and then at least partly recover the second cross-sectional shape. The compliant jacket can include a material that is curable to substantially maintain the second cross-sectional shape or a third cross-sectional shape different from the second cross-sectional shape.

In another example implementation, a method for adhering a tubular assembly onto a constructed surface includes receiving the tubular assembly having a tubular body having a predetermined first cross-sectional shape and a predetermined first cross-sectional area, and a compliant jacket coaxially surrounding the tubular body and having a predetermined second cross-sectional shape and a predetermined second cross-sectional area, arranging the tubular assembly partly within a recess having a third cross-sectional shape defined in a major plane of the constructed surface and a third cross-sectional area, wherein a sum of the first cross-sectional shape and the second cross-sectional area is substantially equal to or less than the third cross-sectional area, and at least partly conforming the compliant jacket from the second cross-sectional shape to the third cross-sectional shape.

Various implementations can include some, all, or none of the following features. The method can includes modifying the second cross-sectional shape to a fourth cross-sectional shape, different from the second cross-sectional shape, and at least partly conforming the compliant jacket from the fourth cross-sectional shape to the third cross-sectional shape. Modifying the second cross-sectional shape to a fourth cross-sectional shape, different from the second cross-sectional shape can include compressing the compliant jacket such that the second cross-sectional area to a fourth cross-sectional area less than the second cross-sectional area. At least partly conforming the compliant jacket from the fourth cross-sectional shape to the third cross-sectional shape can include expanding the compliant jacket from the fourth cross-sectional shape to a fifth cross-sectional area larger than the fourth cross-sectional shape. The compliant jacket can include a substantially incompressible material, and the fourth cross-sectional shape has substantially the second cross-sectional area. The tubular body can be arranged below the major plane. The method can include modifying a portion of the constructed surface to form the recess below the major plane of the constructed surface. At least partly conforming the compliant jacket from the second cross-sectional shape to the third cross-sectional shape can include applying a compressive force over the tubular assembly. Applying a compressive force over the tubular assembly can include rolling a wheel over the tubular assembly and the recess.

In another example embodiment, an apparatus for adhering a tubular assembly to a constructed surface includes a main body moveable in an advancing direction, the main body possessing a forward end and a rear end, a receiver configured to store a tubular assembly, the receiver being mounted on the main body and the tubular assembly having a tubular assembly having a predetermined first cross-sectional shape and a predetermined first cross-sectional area, and a compliant jacket coaxially surrounding the tubular assembly and having a predetermined second cross-sectional shape and a predetermined second cross-sectional area, a tubular assembly applicator configured to receive a portion of the tubular assembly from the receiver and configured to arrange the tubular assembly at least partly within a recess having a third cross-sectional shape defined in a major plane of the constructed surface and a third cross-sectional area, wherein a sum of a first cross-sectional area of the first cross-sectional shape and second cross-sectional area of the second cross-sectional shape substantially equals the third cross-sectional area, and a compressor configured to apply a compressive force over the tubular assembly to at least partly conform the compliant jacket from the second cross-sectional shape to the third cross-sectional shape.

Various embodiments can include some, all, or none of the following features. The apparatus can include a surface modification apparatus connected to the main body, the surface modification apparatus being configured to contact the constructed surface at a contact point to form the recess below a major plane of the constructed surface. The apparatus can include a finisher configured to cure the compliant jacket to the third cross-sectional shape.

The systems and techniques described here may provide one or more of the following advantages. First, a system can provide communications across long distances. Second, the system can reduce the cost of deploying communications cables. Third, the system can increase the speed of communication cable deployment. Fourth, the system can reduce the amount of modification performed to deployment surfaces and locations across which a communication cable is being deployed.

The details of one or more implementations are set forth in the accompanying drawings and the description below. Other features and advantages will be apparent from the description and drawings, and from the claims.

### DESCRIPTION OF DRAWINGS

FIG. 1A show an example of a tubular assembly embedded in a constructed surface.

FIG. 1B show another example of a tubular assembly embedded in a constructed surface.

FIGS. 2A-2E show an example of embedding a tubular assembly in a constructed surface.

FIGS. 3A-3D show another example of embedding a tubular assembly in a constructed surface.

FIGS. 4A-4C show another example of embedding a tubular assembly in a constructed surface.

FIGS. 5A-5C show another example of embedding a tubular assembly in a constructed surface.

FIGS. 6A-6C show another example of embedding a tubular assembly in a constructed surface.

FIG. 7 is a flow diagram of an example process for embedding a tubular assembly in a constructed surface.

FIG. 8 is a flow diagram of another example process for embedding a tubular assembly in a constructed surface.

FIG. 9 shows a perspective view of a tubular assembly deployment apparatus according to embodiments of the disclosure.

FIG. 10 shows a roller machine equipped with a tubular deployment apparatus according to embodiments of the disclosure.

FIG. 11 shows an asphalt paver machine equipped with a tubular deployment apparatus according to embodiments of the disclosure.

### DETAILED DESCRIPTION

This document describes systems and techniques for systems, methods, and apparatuses for laying out a communication line or other tubular assembly and using a protectant to adhere and encase the communication line onto a surface. In general, a constructed surface (e.g., pavement, wall) is modified to form a recess having a predetermined shape, and a communication or other tubular assembly having a shapable outer body is deployed within the recess. The shapable outer body is configured to substantially conform to the predetermined shape of the recess such that the tubular assembly becomes substantially retained within the recess.

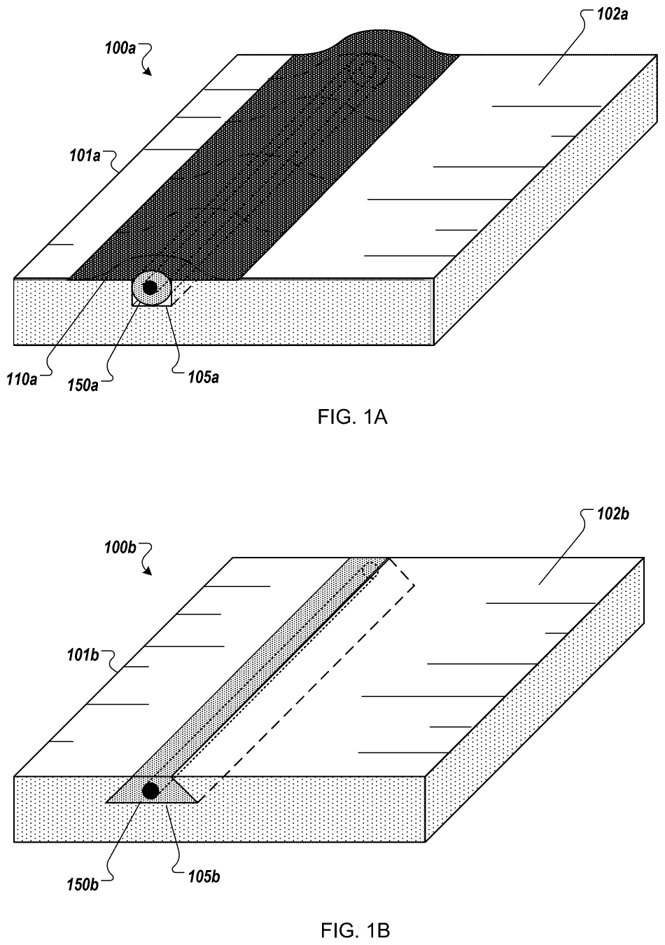

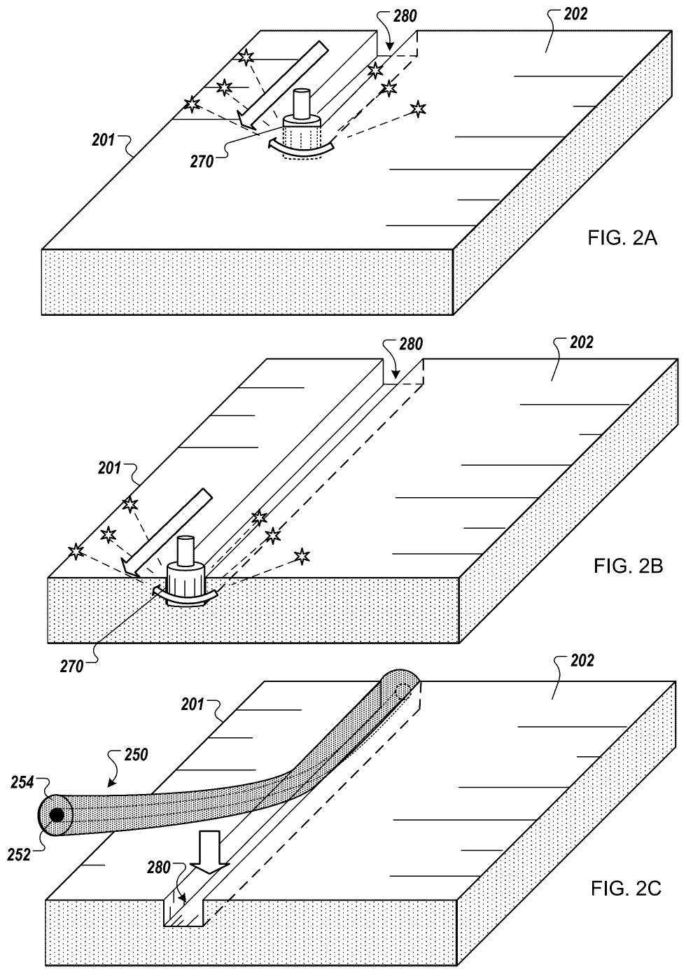

FIG. 1A illustrates an example tubular assembly 150a embedded in a constructed surface 100a such as a road, runway, sidewalk, floor, wall, ceiling, or any other appropriate surface. As indicated by the dotted lines in FIG. 1A, the tubular assembly 150a is underneath a top surface 102a of the constructed surface 100a. The tubular assembly 150a can be deployed towards the edge of the surface 100a. For example, the tubular assembly 150a can be embedded near the shoulder of a road. This can beneficially decrease forces exerted on the tubular assembly 150a by vehicles traveling on the surface 100a. In other embodiments, the tubular assembly 150a can be deployed in the center of a road (e.g., beneath the painted road markings) or in any other appropriate location of the road. In some embodiments, the tubular assembly 150a can be arranged to extend generally longitudinally in parallel to a direction of traffic (e.g., to reduce the frequency of cars or other surface loads crossing over the tubular assembly 150a).

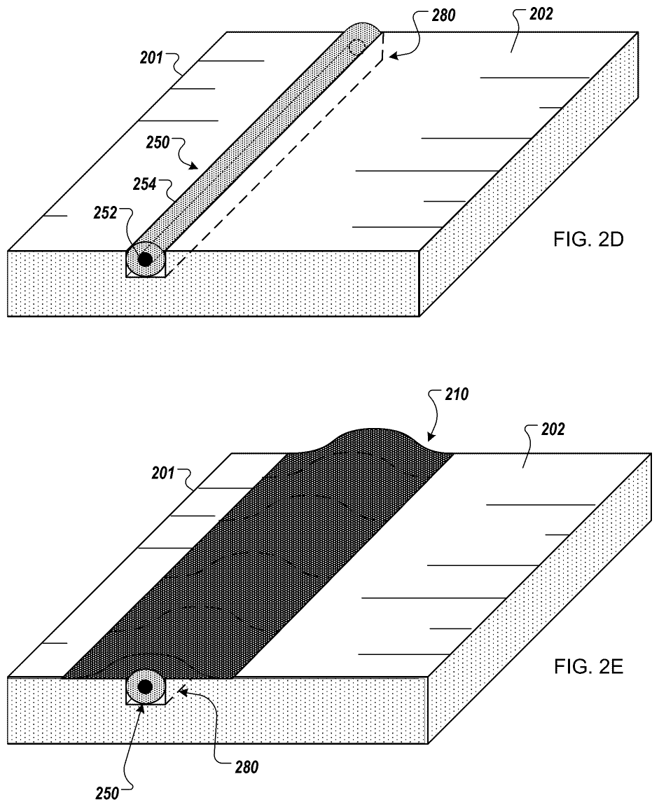

In the illustrated example, the tubular assembly 150a is partly arranged or embedded within a recess 105a defined in the top surface 102a and is then covered by a protective layer 110a. In some embodiments, the tubular assembly 150a may be partly within and partly above the recess 105a. In some embodiments, a fiber optic cable of the tubular assembly 150a may be partly within and partly above the recess 105a, and in other embodiments the fiber optic cable of the tubular assembly 150a may be fully within the recess 105a and remaining parts of the tubular assembly 150a (e.g., protective sheathing) may extend above the recess 105a. The protective layer 110a provides protection for the tubular assembly 150a, and also provides a smooth surface over a portion of the tubular assembly that extends above the top surface 102a. An example of this configuration will be discussed further in the descriptions of FIGS. 2A-2D.

FIG. 1B illustrates an example tubular assembly 150b embedded in a constructed surface 100b such as a road, runway, sidewalk, floor, wall, ceiling, or any other appropriate surface. For example, the tubular assembly 150b can be embedded near the shoulder of a road. This can beneficially decrease forces exerted on the tubular assembly 150b by vehicles traveling on the constructed surface 100b. In other embodiments, the tubular assembly 150b can be deployed in the center of a road (e.g., beneath the painted road markings) or in any other appropriate location of the road. In some embodiments, the tubular assembly 150b can be arranged to extend generally longitudinally in parallel to a direction of traffic (e.g., to reduce the frequency of cars or other surface loads crossing over the tubular assembly 150b).

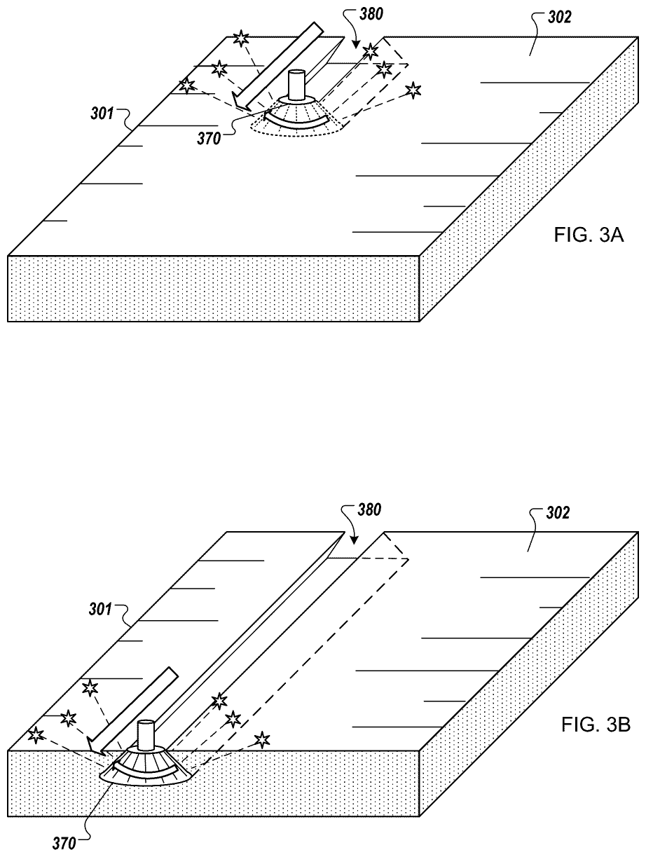

In the illustrated example, the tubular assembly 150b is at least partly arranged or embedded within a recess 105b defined in the top surface 102b. As will be discussed in more detail in the descriptions of FIGS. 3A-6C, the recess 105b is configured to mechanically retain the tubular assembly 150b, and the tubular assembly 150b is configured to at least partly conform to the recess 105b to resist disengagement from the constructed surface 100b.

Paved surfaces can include many layers. In the embodiment illustrated in FIG. 2, the paved surface is a road that includes a base layer 101a. The base layer 101a can include one or more layers of an asphalt layer and/or a concrete layer.

In some embodiments, the tubular assembly 150a and/or 150b can be embedded within any layer of a road and/or in-between any layers of the road during the road building process. In some embodiments, the constructed surface materials can include gravel, earth, asphalt, concrete, or combinations or layers of these and/or any other appropriate materials. In some embodiments, the tubular assembly 150a and/or 150b can be embedded within any layer of a structure and/or in-between any layers of the structure during a structural building process. In some embodiments, the constructed structural materials can include drywall, wood, engineered wood, fiberglass, plaster, plastic, cut or engineered stone slabs, high density foam (e.g., Styrofoam), or combinations or layers of these and/or any other appropriate materials.

FIGS. 2A-2E show an example of embedding a tubular assembly 250 in a constructed surface 201. In some embodiments, the tubular assembly 250 can be the example tubular assembly 150a or 150b of FIGS. 1A and 1B. In some embodiments, the constructed surface 201 can be the example constructed surface 101a or 101b of FIGS. 1A and 1B.

FIGS. 2A and 2B show an example tool 270 being used to contact the top surface 202 at a contact point and define a recess 280 below a top surface 202 of the constructed surface 201. In some embodiments, the tool 270 can be any appropriate surface modification apparatus that can be used to remove a portion of the constructed surface 201 to define the recess 280 (e.g., a trench, groove, depression) with a substantially predetermined shape. For example, the tool 270 can be a saw, a grinder, or a router configured to rotate or reciprocate to cut or loosen the material of the constructed surface 201 to form the recess 280. In another example, the tool 270 can be a wheel configured to apply compressive force against the top surface 202 and compact, compress, or displace the material of the constructed surface 201 to form the recess 280. In another example, the tool 270 can be a blade configured to cut the top surface 202 and displace the material of the constructed surface 201 to form the recess 280.

FIG. 2C shows the tubular assembly 250 being arranged such that it is partly retained within the recess 280. The tubular assembly 250 includes a tubular body 252 coaxially surrounded by protective jacket 254.

In some embodiments, the tubular body 252 can have a predetermined thickness, a predetermined cross-sectional shape, and/or a predetermined cross-sectional area (e.g., the tubular body 252 can have a substantially fixed cross-sectional shape that is substantially incompressible). In some embodiments, the tubular body can include one or more elements comprising one or more of an optical conductor, an electrical conductor, a thermal conductor, or luminal tube. For example, the tubular body 252 can be bare or cladded optical fiber.

In some embodiments, the protective jacket 254 can have a predetermined cross-sectional shape and/or a predetermined cross-sectional area (e.g., the protective jacket 254 can have a substantially fixed cross-sectional shape that is substantially incompressible). In some embodiments, the protective jacket 254 can be a compliant jacket that made of an at least partly compressible material and/or deformable material. Examples of compliant jackets will be discussed in more detail in the descriptions of FIGS. 3A-6C.

In the illustrated example, the recess 280 is defined with a width that is complimentary to (e.g., approximately equal to or slightly wider than) the width of the tubular assembly 250 and is defined with a depth that is less than the height of the tubular assembly 250. In the illustrated example, the recess 280 has a depth that is slightly greater than the radius of the tubular assembly 250.

Referring to FIG. 2D, the tubular assembly 250 has been laid down at least partly within the recess 280. As best shown in this view, the recess 280 has a depth such that the tubular body 252 is partly or entirely arranged below the plane of the top surface 202.

FIG. 2E shows the constructed surface 201 after the tubular assembly 250 has been encased within the recess 280 by a protectant 210 (e.g., resin). In general, after the tubular assembly 250 has been arranged within the recess 280, an uncured protectant is applied (e.g., poured, brushed, sprayed) over the tubular assembly 250 and the recess 280. The uncured protectant is configured to cure after the uncured protectant is applied to form the protectant 210 to protectively encase tubular assembly 250 and adhere or otherwise retain the tubular assembly 250 to the constructed surface 201. For example, the protectant 210 can provide physical protection against actions on the top surface 202 (e.g., wheels, foot traffic, flowing water or other fluids, abrasion from sand or other debris). In another example, the protectant 210 can provide physical protection against ambient conditions on the top surface 202 (e.g., the sun's ultraviolet rays, road salt or deicers, cleaners or other chemicals, ozone). In another example, the protectant 210 can substantially seal the recess 280 against ingress of materials from the top surface (e.g., to prevent water from entering the recess 280 and freezing). In another example, the protectant 210 can provide a smooth surface for surface traffic (e.g., to make it easier for wheels to traverse the recess 280, to reduce tripping hazards, to reduce turbulence in flowing fluids). For example, the uncured protectant can be or include a resin. The uncured protectant may be, for example, a methyl methacrylate (MMA) that can be cured by being mixed with a catalyst. For example, benzoyl peroxide (BPO) can be used as a catalyst to interact with MMA. Additionally or alternatively, the uncured protectant may include an epoxy and/or polyurea. For example, a two-part epoxy may be used that mix immediately prior to, during, or immediately after being applied. Epoxy or polyurea primers may also be used. Protective flakes may be used or added to the uncured protectant. These materials are simply discussed to provide some examples. Any combinations of these materials and other appropriate known protective materials may be utilized for the uncured protectant.

FIGS. 3A-3D show an example of embedding an example tubular assembly 350 in an example constructed surface 301. In some embodiments, the tubular assembly 350 can be the example tubular assembly 150a or 150b of FIGS. 1A and 1B. In some embodiments, the constructed surface 301 can be the example constructed surface 101a or 101b of FIGS. 1A and 1B.

FIGS. 3A and 3B show an example tool 370 being used to define a recess 380 below a top surface 302 of the constructed surface 301. In some embodiments, the tool 370 can be any appropriate surface modification apparatus that can be used to remove a portion of the constructed surface 301 to define the recess 380 (e.g., a trench, groove, depression) with a substantially predetermined shape. For example, the tool 370 can be a saw or a router configured to rotate or reciprocate to cut or loosen the material of the constructed surface 301 to form the recess 380. In another example, the tool 370 can be a wheel configured to apply compressive force against the top surface 302 and compact, compress, or displace the material of the constructed surface 301 to form the recess 380. In another example, the tool 370 can be a blade configured to cut the top surface 302 and displace the material of the constructed surface 301 to form the recess 380.

FIG. 3C shows the tubular assembly 350 being arranged such that it is partly or entirely retained within the recess 380. The tubular assembly 350 includes a tubular body 352 coaxially surrounded by protective jacket 354.

In some embodiments, the tubular body 352 can have a predetermined cross-sectional shape and/or a predetermined cross-sectional area (e.g., the tubular body 352 can have a substantially fixed cross-sectional shape that is substantially incompressible). In some embodiments, the tubular body can include one or more elements comprising one or more of an optical conductor, an electrical conductor, a thermal conductor, or luminal tube. For example, the tubular body 352 can be bare or cladded optical fiber.

In some embodiments, the protective jacket 354 can have a predetermined cross-sectional shape and/or a predetermined cross-sectional area. For example, the protective jacket 354 can be flexible but substantially incompressible (e.g., elastic material, rubbery material) such that the shape of the protective jacket 354 can be distorted by external forces to permit passage into the recess 380, and when those forces are relieved the protective jacket 354 can return toward its original shape within the recess 380.

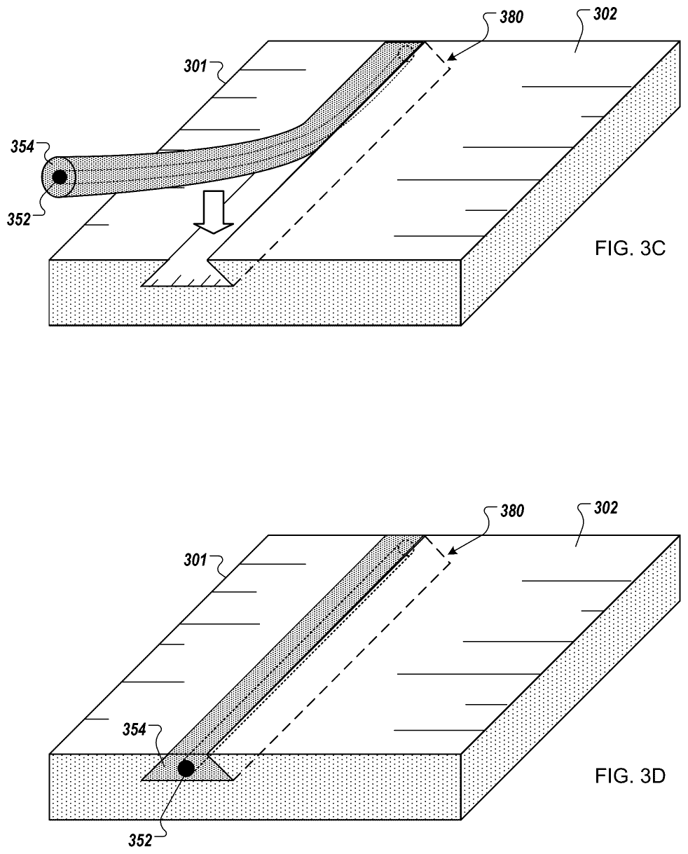

In some embodiments, the protective jacket 354 can be a compliant jacket that is compressible and/or deformable. For example, the protective jacket 354 can be partly made of an elastic foam or other material that can be compressed by external forces (e.g., squeezed, squished, compacted) to permit passage into the recess 380, and when those forces are relieved the protective jacket 354 can re-expand toward its original shape within the recess 380. Additional examples of compliant jackets will be discussed in more detail in the descriptions of FIGS. 4A-6C.

Referring to FIG. 3D, the tubular assembly 350 has been laid down at least partly within the recess 380. As best shown in this view, the recess 280 has a depth such that the tubular body 352 is partly or entirely arranged below the plane of the top surface 302.

FIGS. 4A-4C show another example of embedding the example tubular assembly 350 in the example constructed surface 301. In FIG. 4A, the tubular assembly 350 is positioned over an opening 480 of the recess 380. The tubular assembly 350 is shown in a default (e.g., pre-installation) configuration, in which the protective jacket 354 coaxially surrounding the tubular body 352 is in a substantially undeformed (e.g., undistorted, uncompressed) default shape. The tubular body 352 has a predetermined thickness, a predetermined cross-sectional shape, and a predetermined cross-sectional area (e.g., an electrical or optical conductor having a substantially round and substantially incompressible and/or distortable shape). The protective jacket 354 is a compliant jacket coaxially surrounding the tubular body 352 and has a predetermined cross-sectional shape and a predetermined cross-sectional area.

The protective jacket 354 is made of one or more materials that can be compressed and/or reshaped (e.g., squeezed, squished) from the predetermined configuration under force to have a different cross-sectional shape and/or a smaller cross-sectional area, and then flex and/or expand back toward the undeformed configuration when released. The protective jacket 354 may be, for example, an elastomer, plastic, rubber, foam, or gel. Any appropriate material that can be compressed and/or reshaped as described herein may be utilized for the protective jacket 354.

In FIG. 4B, the protective jacket 354 has been compressed and distorted from its default shape such that it can be passed through the opening 480 into the recess 380. The example recess 380 is formed with a trapezoidal cross-sectional shape, in which the opening 480 defines what would otherwise be the minor base of the trapezoidal shape, and then the recess widens away from the opening 480 below the top surface 302. In the illustrated example, this process of squeezing the tubular assembly 350 into the recess 380 continues until the tubular assembly 350 is substantially entirely within the recess 380 below the top surface 302.

In FIG. 4C, the tubular assembly 350 has been substantially entirely inserted within the recess 380 below the top surface 302. Pressure has been applied to cause the protective jacket 354 to cause the protective jacket 354 to partly flow until it touches the walls of the recess 380 and substantially fill the available space within the recess 380. The deformed shape of the protective jacket 354 at least partly retains the tubular assembly 350 and the tubular body 352 within the recess, substantially below the top surface 302. In some embodiments, a portion of the protective jacket 354 may extend at least partly above the plane of the top surface 302, and in some such examples, a curable protectant may be applied over the top of the tubular assembly 350 and the recess 380 (e.g., similar to the example protectant 210 of FIG. 2E).

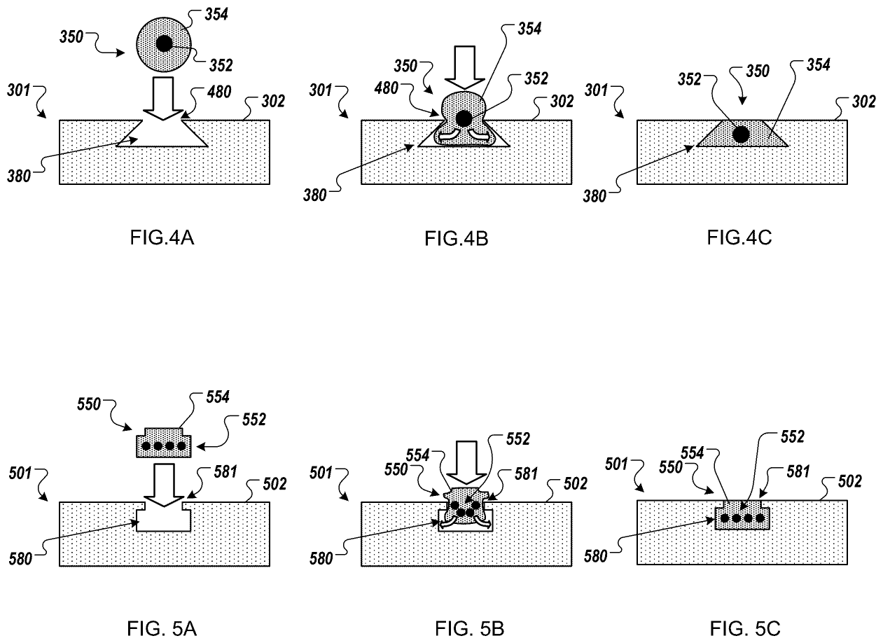

FIGS. 5A-5C show another example of embedding an example tubular assembly 550 in an example constructed surface 501. In some embodiments, the tubular assembly 550 can be the example tubular assembly 150a or 150b of FIGS. 1A and 1B. In some embodiments, the constructed surface 501 can be the example constructed surface 101a or 101b of FIGS. 1A and 1B.

In FIG. 5A, the tubular assembly 550 is positioned over an opening 581 of a recess 580. The tubular assembly 550 is shown in a default (e.g., pre-installation) configuration, in which a protective jacket 554 surrounding an arrangement of tubular bodies 552 is in a substantially undeformed (e.g., undistorted, uncompressed) default shape that is configured to compliment the predetermined cross-sectional shape of the recess 580. The tubular bodies 552 each have a predetermined cross-sectional shape and a predetermined cross-sectional area (e.g., an electrical or optical conductor having a substantially round and substantially incompressible and/or distortable shape).

The protective jacket 554 is a compliant jacket surrounding the arrangement of tubular bodies 552. The tubular bodies 552 are spaced and arranged within the protective jacket 554 in a predetermined configuration. For example, the tubular bodies 552 can be optical fibers and can be spaced apart to substantially prevent optical crosstalk. In another example, the tubular bodies 552 can be electrical conductors and can be spaced apart to promote electromagnetic isolation, to promote electromagnetic shielding, and/or to maintain a predetermined inter-conductor impedance or capacitance. For example, the tubular assembly 550 can be configured as an Ethernet cable assembly in which twisted pairs of conductors are held in a predetermined physical arrangement with each other (e.g., as prescribed by IEEE 802.X specifications) by the protective jacket 554.

The protective jacket 554 is made of one or more materials that can be distorted and/or reshaped (e.g., squeezed) from the predetermined configuration under force to have a different cross-sectional shape, and then flex back toward the undeformed configuration when released.

In FIG. 5B, the protective jacket 554 has been distorted from its default shape such that it can be passed through the opening 581 into the recess 580. The example recess 580 is formed with generally rectangular cross-sectional shape, in which the opening 581 defines a narrow passage to a wider rectangular cavity below the top surface 502. In the illustrated example, this process of squeezing the tubular assembly 550 into the recess 580 continues until the tubular assembly 550 is substantially entirely within the recess 580 below the top surface 502.

In FIG. 5C, the tubular assembly 550 has been substantially entirely inserted within the recess 580 below the top surface 502. Upon release, the protective jacket 554 self-restores, undistorting back toward its default shape such that it substantially fills the available space within the recess 580, and returns the collection of tubular bodies 552 back to their predefined interpositional configuration. The partly restored shape of the protective jacket 554 at least partly retains the tubular assembly 550 and the tubular body 552 within the recess, substantially below the top surface 502, and maintains the positional configuration of the collection of tubular bodies 552. In some embodiments, a portion of the protective jacket 554 may restore at least partly above the plane of the top surface 502, and in some such examples, a curable protectant may be applied over the top of the tubular assembly 550 and the recess 580 (e.g., similar to the example protectant 210 of FIG. 2E).

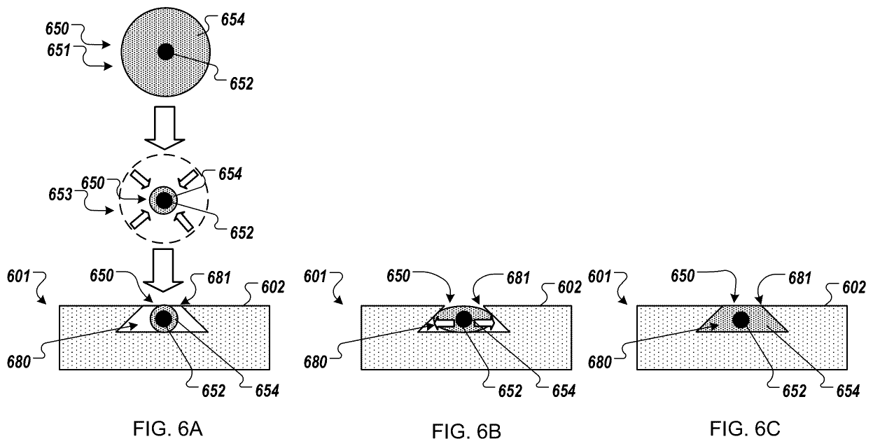

FIGS. 6A-6C show another example of embedding an example tubular assembly 650 in an example constructed surface 601. In some embodiments, the tubular assembly 650 can be the example tubular assembly 150a or 150b of FIGS. 1A and 1B. In some embodiments, the constructed surface 601 can be the example constructed surface 101a or 101b of FIGS. 1A and 1B.

In FIG. 6A, the tubular assembly 650 is positioned over an opening 681 of a recess 680. The tubular assembly 650 is shown in a default (e.g., pre-installation) configuration 651, in which a protective jacket 654 coaxially surrounding a tubular body 652 is in a substantially undeformed (e.g., undistorted, uncompressed) default shape. The tubular body 652 has a predetermined cross-sectional shape and a predetermined cross-sectional area (e.g., an electrical or optical conductor having a substantially round and substantially incompressible and/or distortable shape). The protective jacket 654 is a compressible jacket coaxially surrounding the tubular body 652 and has a predetermined cross-sectional shape and a predetermined cross-sectional area.

The protective jacket 654 is made of one or more materials that can be compressed and/or reshaped (e.g., squeezed, squished) from the predetermined configuration under force to a deformed configuration 653, which has a different cross-sectional shape and/or a smaller cross-sectional area from the undeformed configuration 651, and can fit through the opening 681 to be arranged within the recess 680.

The example recess 680 is formed with a trapezoidal cross-sectional shape, in which the opening 681 defines what would otherwise be the minor base of the trapezoidal shape, and then the recess widens away from the opening 681 below the top surface 602. While the example recess 680 is formed with a trapezoidal cross-sectional shape in the illustrated example, any appropriate cross-sectional shape can be used. For example, an inverted “T” shape (e.g., the example recess 580 of FIGS. 5A-5C), an ovoid or otherwise rounded shape could be used. In some embodiments, by defining the opening 681 to have a narrower width than at least a portion of the recess 680 below, mechanical retention of the tubular assembly 650 may be promoted. In the illustrated example, the process of squeezing the tubular assembly 650 into the recess 680 continues until the tubular assembly 650 is substantially entirely within the recess 680 below the top surface 602.

In FIG. 6B, the tubular assembly 650 has been inserted into the recess 680 and the compression applied to the protective jacket 654 has been released. After release, the protective jacket 654 starts to expand away from the distorted configuration 653.

In FIG. 6C, the protective jacket 354 has partly self-restored, at least partly undistorting and/or expanding back toward its default shape until it touches the walls of the recess 680 until it substantially fills the available space within the recess 680. The partly restored shape of the protective jacket 654 at least partly retains the tubular assembly 650 and the tubular body 652 within the recess, substantially below the top surface 602. In some embodiments, a portion of the protective jacket 654 may restore or re-expand at least partly above the plane of the top surface 602, and in some such examples, a curable protectant may be applied over the top of the tubular assembly 650 and the recess 380 (e.g., similar to the example protectant 210 of FIG. 2E).

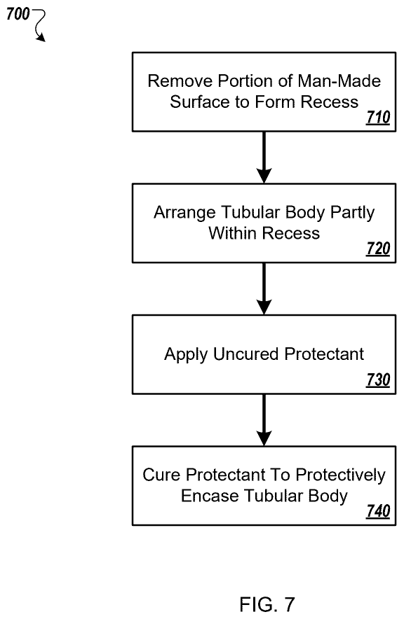

FIG. 7 is a flow diagram of an example process 700 for embedding a tubular assembly in a constructed surface.

At 710, a portion of a constructed surface is removed to form a recess below a major plane of the constructed surface. For example, the example tool 270 of FIGS. 2A and 2B can be used to remove a portion of the constructed surface 201 to form the recess 280 below the top surface 202.

At 720, a tubular assembly is arranged partly within the recess. For example, as shown in FIGS. 2C and 2D, the example tubular assembly 250 can be at least partly inserted into the recess 280.

At 730, an uncured protectant is applied over the tubular assembly and the recess. For example, as shown in FIG. 2E, the example protectant 210 can be applied over the tubular assembly 250 in the recess 280. In some embodiments, the protectant 210 can go on as a liquid or gel. In some embodiments, the protectant 210 can be a flexible solid in its uncured form (e.g., a tape or band) that can be laid down over the tubular assembly 250 and the recess 280.

At 740, the uncured protectant is cured to protectively encase the tubular assembly. For example, in some embodiments the protectant 210 can go on as a liquid or gel and then cured to a substantially solid state (e.g., evaporative curing, by exposing light sensitive protectant to ultraviolet light, a catalyst or other chemical curing agents can be applied). In some embodiments, the protectant 210 can be a flexible solid in its uncured form (e.g., a tape or band) that can be laid down over the tubular assembly 250 and the recess 280, and then cured into a harder state.

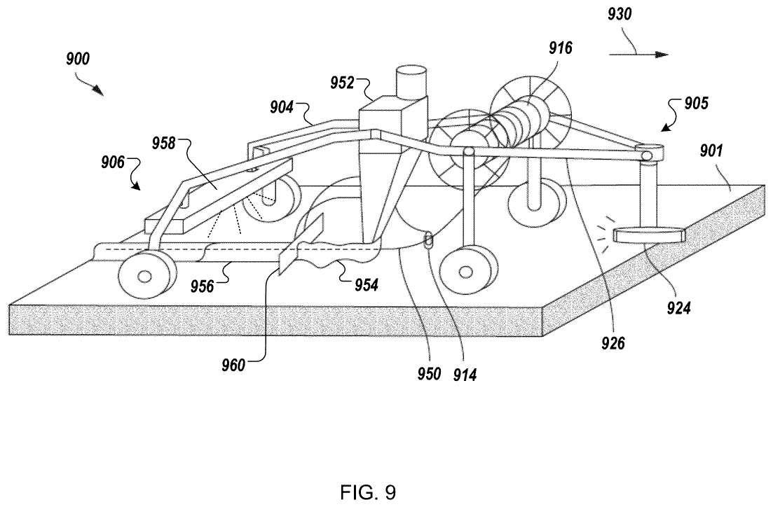

In some embodiments, the uncured protectant can be shaped or formed before curing the uncured protectant such that the uncured protectant has a different cross-sectional shape after the shaping than prior to the shaping. In some embodiments, the shaping can be performed after the uncured protectant is applied onto the tubular assembly. An example of a shaper for shaping uncured protectant will be discussed further in the description of FIG. 9.

In some embodiments, the tubular assembly can be applied directly to the recess, and the uncured protectant is applied directly onto the tubular assembly. For example, the example tubular assembly 250 can be inserted into the recess 280 without first distorting or compressing the tubular assembly 250.

In some embodiments, the curing of the uncured protectant forms a cured protectant that protectively encases the tubular assembly at least partly within the recess, the cured protectant being an outermost layer protecting the tubular assembly at least partly within the recess. For example, the tubular body 252 can be arranged within a layer of the protectant 210 (e.g., with or without the protective jacket 254), such that when the protectant 210 is cured, the protectant performs some or all of the functions of the protective jacket 254 (e.g., to act as an optical cladding or electrical insulator, to promote retention within the recess, to protect against hazards at the top surface 202.

In some embodiments, the tubular assembly can have a predetermined diameter or thickness, and the recess can a depth that is less than the predetermined diameter or thickness. For example, the example recess 280 is not so deep that the tubular assembly 250 is completely recessed below the plane of the top surface 202.

In some implementations, the process 700 can include applying the uncured protectant onto the tubular assembly and curing the uncured protectant to cover the tubular assembly. For example, in the examples shown in FIGS. 2A-2E, the protectant 210 covers the tubular assembly 250 and is cured to a substantially solid form.

In some implementations, the process 700 can include applying the uncured protectant within the recess and curing the uncured protectant to cover the tubular assembly. For example, the protectant 210 can be applied into the recess before the tubular assembly 250 is inserted. In examples such as this, the tubular assembly 250 can at least partly sink into the uncured protectant before the protectant is cured, retaining the tubular assembly 250 within the protectant.

In some implementations, a first portion of the tubular assembly can be arranged below the major plane and a second portion of the tubular assembly can extends beyond the major plane, and the uncured protectant can be cured to protectively encase the first portion within the recess and cover the second portion beyond the major plane. For example, the example tubular assembly 250 extends partly above the plane of the top surface 202, and the protectant 210 not only encases the tubular assembly 250 within the recess, it also forms a protective cap over the top of the tubular assembly 250 and the recess 280.

In some embodiments, the tubular assembly can include an optical conductor. For example, one or more of the example tubular assemblies 250, 350, 550, and 650 can be fiber optic cables. In some embodiments, the tubular assembly can include an electrical conductor. For example, one or more of the example tubular assemblies 250, 350, 550, and 650 can be electrical power or communication cables. In some embodiments, the tubular assembly can include a tubular lumen. For example, one or more of the example tubular assemblies 250, 350, 550, and 650 can be a tube configured to carry a fluid.

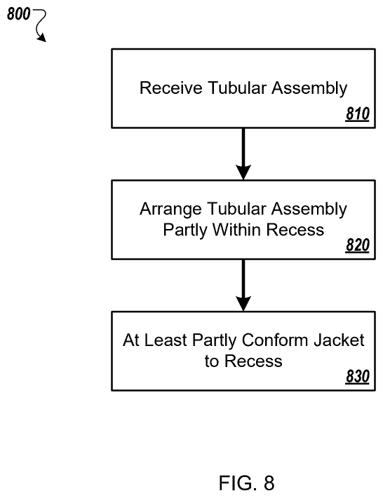

FIG. 8 is a flow diagram of another example process 800 for embedding a tubular assembly in a constructed surface.

At 810 the tubular assembly is received. The tubular assembly includes a tubular body having a predetermined first cross-sectional shape and a predetermined first cross-sectional area, and a compliant jacket coaxially surrounding the tubular body and having a predetermined second cross-sectional shape and a predetermined second cross-sectional area. For example, in FIGS. 4A-4C, the example tubular assembly 350 includes the tubular body 352, which is configured to substantially maintain its cross section shape, and the protective jacket 354, which is configure to be compressed and/or deformed away from an initial cross-sectional shape (e.g., as shown in FIG. 4A) to a second, different cross-sectional shape (e.g., as shown in FIGS. 4B and 4C).

At 820, the tubular assembly is arranged partly within a recess having a third cross-sectional shape defined in a major plane of the constructed surface and a third cross-sectional area, where the sum of the first cross-sectional area and the second cross-sectional area is substantially equal to or less than the third cross-sectional area. For example, the example recess 380 is configured with a cross-sectional area that is smaller than the total cross sectional area of the tubular assembly 350 as shown in example configuration of FIG. 4A.

At 830, the compliant jacket is at least partly conformed from the second cross-sectional shape to the third cross-sectional shape. In some implementations, the process 800 can include modifying the second cross-sectional shape to a fourth cross-sectional shape, different from the second cross-sectional shape, at least partly conforming the compliant jacket from the fourth cross-sectional shape to the third cross-sectional shape. For example, the example tubular assembly 350 is deformed from an initial shape (e.g., as shown in FIG. 4A) and inserted into the recess 380 (e.g., FIG. 4B), and is then compressed to partly flow and at least partly fill the recess 380 (e.g., FIG. 4C).

In some implementations, the process 800 can include modifying the second cross-sectional shape to a fourth cross-sectional shape, different from the second cross-sectional shape further comprises compressing the compliant jacket such that the second cross-sectional area to a fourth cross-sectional area less than the second cross-sectional area. In some implementations, at least partly conforming the compliant jacket from the fourth cross-sectional shape to the third cross-sectional shape can include expanding the compliant jacket from the fourth cross-sectional area to a fifth cross-sectional area larger than the fourth cross-sectional area. For example, the example tubular assembly 650 is deformed from the undistorted configuration 651 (e.g., as shown in FIG. 6A) to the compressed configuration 653, is then and inserted into the recess 680 (e.g., FIG. 6B), and is then allowed to partly re-expand to at least partly fill the recess 680 (e.g., FIG. 6C).

In some implementations, the compliant jacket can include a substantially incompressible material, and the fourth cross-sectional shape has substantially the second cross-sectional area. For example, the example protective jacket 554 of FIGS. 5A-5C has a cross-sectional shape that is substantially the same as the cross-sectional shape of the example recess 480.

In some implementations, the tubular body can be arranged below the major plane. For example, in the example configurations shown in FIGS. 4A-6C, the example tubular bodies 352, 552, and 652 are arranged below the planes define by the corresponding top surfaces 302, 502, and 602.

In some implementations, the process 800 can include modifying a portion of the constructed surface to form the recess below the major plane of the constructed surface. For example, as shown in FIGS. 2A, 2B, 3A, and 3B, the tools 270 and 370 are used to remove portions of the constructed surfaces 201 and 301 to define the recesses 280 and 380.

In some implementations, at least partly conforming the compliant jacket from the second cross-sectional shape to the third cross-sectional shape can include applying a compressive force over the tubular assembly. For example, as shown in the examples of FIGS. 4A-4C, the example tubular assembly 350 can be pressed or “squished” into the recess 380 to cause the protective jacket 354 to conform to the shape of the recess 380.

In some implementations, applying a compressive force over the tubular assembly can include rolling a wheel over the tubular assembly and the recess. Examples of devices that can be used to apply tubular members to recesses will be discussed in more detail in the descriptions of FIGS. 9-11.

FIG. 9 illustrates a perspective view of a tubular assembly deployment apparatus 900 according to embodiments of the disclosure. An example embodiment of a tubular assembly deployment apparatus is disclosed in U.S. Pat. No. 10,866,380, which is hereby incorporated by reference herein in its entirety. The tubular assembly deployment apparatus 900 can include a spool 916 mounted to a forward end 905 of a chassis 926 of a main body 904. The spool 916 can hold a predetermined length of tubular assembly 950 such as optical fiber or communication line (e.g., the tubular assemblies 150a, 150b, 250, 350, 550, 650). As illustrated, the tubular assembly 950 can be wound around the spool 916. The tubular assembly 950 can unwind from spool 916 at a rate commensurate with the apparatus speed in the direction of travel 930 (e.g., advancing direction) across a constructed surface 901. The tubular assembly 950 can pass through a tubular assembly applicator 914 before the tubular assembly 950 is placed directly on or in the respective layer. The tubular assembly applicator 914 can be mounted to the chassis 926. The tubular assembly applicator 914 can be a ring, tube, or similar structure to guide the application of the tubular assembly 950 on or in the respective layer.

In some embodiments, the tubular assembly deployment apparatus 900 can include a smoothing apparatus 924 as shown in FIG. 9. For example, the tool 270 or 370 can be configured to contact the constructed surface 901 to form recesses with bottoms that are substantially smooth (e.g., relatively smoother than the proximal portions of the top surface of the constructed surface 901). In other embodiments, the smoothing apparatus 924 can be omitted. For example, an embodiment of a tubular assembly deployment apparatus without a smoothing apparatus is disclosed in U.S. Pat. No. 9,588,315, which is hereby incorporated by reference herein in its entirety. Other examples of a tubular assembly deployment apparatus are disclosed in International Patent Publication No. WO 2022/010553, which is also hereby incorporated by reference herein in its entirety.

After the tubular assembly 950 is deployed onto or at least partly into the top surface of the constructed surface 901, a container and protectant applicator 952 stores and ejects an uncured protectant 954 over the tubular assembly 950. A shaping tool 960 is advanced over the uncured protectant 954 to urge the uncured protectant 954 toward a predetermined cross-sectional shape 956. A finisher 958 proximal a rear end 906 is configured to cure the uncured protectant 954 into substantially the predetermined cross-sectional shape 956. The shaped, uncured protectant 956 is then cured into a substantially solid form (e.g., by drying, by exposure to sun or other ultraviolet light, by application of a hardening agent).

In some embodiments, a tubular assembly deployment apparatus 900 can be used to deploy the tubular assembly 950 onto the top surface of a layer of road or other constructed surface before a subsequent layer is applied on top. For example, the tubular assembly 950 can be deployed onto a sub-base layer by the tubular assembly deployment apparatus 900 before a base layer is laid.

In other embodiments, the tubular assembly 950 can be deployed onto the top surface of a layer of constructed surface by the tubular assembly deployment apparatus 900 and then pushed into (“smushed into”) that layer using, for example, a roller machine. For example, the tubular assembly 950 can be deployed onto the top surface of the constructed surface 901 and pressed into the constructed surface 901 when the apparatus 900 compacts the constructed surface 901. In some embodiments, in order to push the tubular assembly 950 into a layer, the layer may be capable of receiving the tubular assembly 950. For example, if the layer comprises asphalt or concrete, the asphalt or concrete may not have cured yet. For another example, if the layer includes gravel, the gravel may not be compacted so densely that it cannot receive the tubular assembly 950. Optionally, a subsequent layer can be laid on top of the layer that the tubular assembly has been pushed in to, for example, when the tubular assembly 950 is pushed into a sub-base layer and a base layer can be laid on top.

In addition to the embodiments discussed above, when repaving an existing road, the tubular assembly 950 can be deployed after the old road is milled and before the new base layer is laid. Further, when adding a subsequent base layer to an existing road, the tubular assembly 950 can be laid on top of the old base layer before the new base layer is laid or it can be laid on top of and pushed into the new base layer.

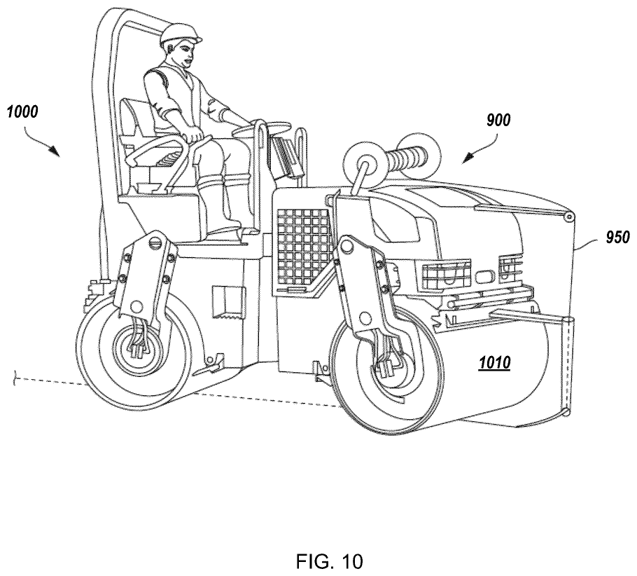

In some embodiments, a tubular assembly 950 can be deployed while performing a step of the road forming process. For example, the tubular assembly 950 can be deployed while laying or compacting a sub-grade layer, a sub-base layer, or base layers. For example, road-building equipment can include a tubular assembly deployment apparatus to deploy the tubular assembly 950 while performing other roadbuilding steps. For example, as shown in FIG. 10, a roller machine 1000 can be equipped with the tubular assembly deployment apparatus 900 to deploy the tubular assembly 950 in front of the roller machine 1000 so that the roller machine 1000 deploys the tubular assembly 950 while applying its compacting force to roll, smooth, and/or set the layer. For example, the roller machine 1000 has a roller 1010 that can function as a compressor to urge the tubular assembly 950 into a recess defined in the constructed surface 901. The roller machine 1000 can thereby apply the tubular assembly 950, apply and/or push it into the layer, and compact the layer in one continuous process.

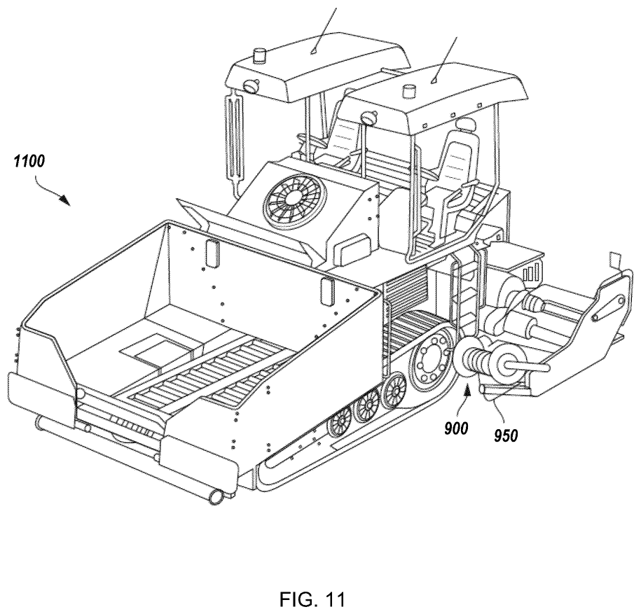

For another example, as shown in FIG. 11, an asphalt paver machine 1100 can be equipped with a tubular assembly deployment apparatus 900 to deploy a tubular assembly 950 while laying asphalt in front of the asphalt paver machine 1100 so that the asphalt paver machine 1100 deploys the tubular assembly 950 and lays asphalt with the tubular assembly 950 and/or on top of the tubular assembly 950. The asphalt paver machine 1100 merely provides an example of one type of machine that can form a layer of a paved surface. Any type of paver machine or material-depositing machine that is used to form any layer of a paved surface could be equipped, similar to the example shown in FIG. 11, to include a tubular assembly deployment apparatus 900 to deploy the tubular assembly 950 simultaneously with, or in conjunction to, forming the layer.

Although the foregoing embodiments describe a tubular assembly deployment apparatus 900 attached to a roller machine 1000 and an asphalt paver machine 1100, the disclosed subject matter is not so limited. Instead, as one of ordinary skill in the art will appreciate, the deployment system can be attached to any piece of equipment used for road building, including, for example, a dump truck configured to store and dump one of asphalt and concrete, a miller configured to destroy a layer of an existing road, a sweeper configured to remove debris from a first surface, or a piece of equipment including a nozzle configured to distribute tack coat onto a surface.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method for adhering a tubular assembly onto a constructed surface, the method comprising:
removing a portion of the constructed surface to form a recess below a major plane of the constructed surface;
arranging the tubular assembly partly within the recess;
applying an uncured protectant; and
curing the uncured protectant to protectively encase the tubular assembly.

2. The method of claim 1, further comprising shaping the uncured protectant before curing the uncured protectant such that the uncured protectant has a different cross-sectional shape after the shaping than prior to the shaping.

3. The method of claim 1, wherein:
the tubular assembly is applied directly to the recess; and
the uncured protectant is applied directly onto the tubular assembly.

4. The method according to claim 1, wherein the curing of the uncured protectant forms a cured protectant that protectively encases the tubular assembly at least partly within the recess, the cured protectant being an outermost layer protecting the tubular assembly at least partly within the recess.

5. The method of claim 1, wherein the tubular assembly has a predetermined thickness, and the recess has a depth less than the predetermined thickness.

6. The method of claim 1, further comprising:
applying the uncured protectant onto the tubular assembly; and
curing the uncured protectant to cover the tubular assembly.

7. The method of claim 1, further comprising:
applying the uncured protectant within the recess; and
curing the uncured protectant to cover the tubular assembly.

8. The method of claim 1, wherein a first portion of the tubular assembly is arranged below the major plane and a second portion of the tubular assembly extends beyond the major plane, and the uncured protectant is cured to protectively encase the first portion within the recess and cover the second portion beyond the major plane.

9. The method of claim 1, wherein the tubular assembly comprises an optical conductor.

10. An apparatus for adhering a tubular assembly to a constructed surface, the apparatus comprising:
a main body moveable in an advancing direction, the main body possessing a forward end and a rear end;
a receiver configured to store a tubular assembly having a predetermined thickness, the receiver being mounted on the main body;
a container configured to store an uncured protectant, the container being mounted on the main body;
a surface modification apparatus connected to the main body, the surface modification apparatus being configured to contact the constructed surface at a contact point to form a recess below a major plane of the constructed surface when the apparatus moves in the advancing direction;
a tubular assembly applicator configured to receive a portion of the tubular assembly from the receiver and configured to arrange the tubular assembly partly within the recess; and
a protectant applicator connected to the container and configured to eject the uncured protectant wherein the uncured protectant is configured to cure after the uncured protectant is applied.

11. The apparatus of claim 10, wherein the surface modification apparatus is a grinder or a wheel.

12. The apparatus of claim 10, wherein the uncured protectant is a resin.

13. The apparatus of claim 10, wherein the uncured protectant is configured to be cured by application of a catalyst configured to initiate a curing process.

14. The apparatus of claim 10, wherein the surface modification apparatus is configured to form the recess to a depth less than the predetermined thickness below the major plane.

15. The apparatus of claim 10, wherein the protectant applicator is configured to eject the uncured protectant onto the tubular assembly, and the protectant applicator is positioned such that ejected uncured protectant is applied after the tubular assembly has been arranged by the tubular assembly applicator.

16. The apparatus of claim 10, wherein the protectant applicator is configured to eject the uncured protectant into the recess, and the protectant applicator is positioned such that ejected uncured protectant is applied after the tubular assembly has been arranged by the tubular assembly applicator.

17. The apparatus of claim 10, wherein the protectant applicator is configured to eject the uncured protectant into the recess, and the protectant applicator is positioned such that ejected uncured protectant is applied before the tubular assembly is arranged by the tubular assembly applicator.

18. The apparatus of claim 10, wherein the tubular assembly applicator is configured to arrange the tubular assembly partly within the recess such that a first portion of the tubular assembly is arranged below the major plane and a second portion of the tubular assembly extends beyond the major plane.

19. A method for adhering a tubular assembly onto a constructed surface, the method comprising:
receiving the tubular assembly comprising:
a tubular body having a predetermined first cross-sectional shape and a predetermined first cross-sectional area; and
a compliant jacket coaxially surrounding the tubular body and having a predetermined second cross-sectional shape and a predetermined second cross-sectional area;
arranging the tubular assembly partly within a recess having a third cross-sectional shape defined in a major plane of the constructed surface and a third cross-sectional area, wherein a sum of the predetermined first cross-sectional shape and the predetermined second cross-sectional area is substantially equal to or less than the third cross-sectional area; and
at least partly conforming the compliant jacket from the predetermined second cross-sectional shape to the third cross-sectional shape.

20. An apparatus for adhering a tubular assembly to a constructed surface, the apparatus comprising:
a main body moveable in an advancing direction, the main body possessing a forward end and a rear end;
a receiver configured to store a tubular assembly, the receiver being mounted on the main body and the tubular assembly comprising:
a tubular assembly having a predetermined first cross-sectional shape and a predetermined first cross-sectional area; and
a compliant jacket coaxially surrounding the tubular assembly and having a predetermined second cross-sectional shape and a predetermined second cross-sectional area;
a tubular assembly applicator configured to receive a portion of the tubular assembly from the receiver and configured to arrange the tubular assembly at least partly within a recess having a third cross-sectional shape defined in a major plane of the constructed surface and a third cross-sectional area, wherein a sum of a first cross-sectional area of the predetermined first cross-sectional shape and second cross-sectional area of the predetermined second cross-sectional shape substantially equals the third cross-sectional area; and
a compressor configured to apply a compressive force over the tubular assembly to at least partly conform the compliant jacket from the predetermined second cross-sectional shape to the third cross-sectional shape.
